(19) United States
(12) Patent Application Publication
(10) Pub. No.: US 2013/0191171 A1
(43) Pub. Date: Jul. 25, 2013

(54) RESERVATION CONTAINER OBJECT AND REFERENCE THERETO

(71) Applicants: Stuart P. WALDRON, Fishkill, NY (US); Jose E. PEPITO, Vienna, VA (US)

(72) Inventors: Stuart P. WALDRON, Fishkill, NY (US); Jose E. PEPITO, Vienna, VA (US)

(73) Assignee: NATIONAL RAILROAD PASSENGER CORPORATION, Washington, DC (US)

(21) Appl. No.: 13/353,793

(22) Filed: Jan. 19, 2012

(51) Int. Cl. G06Q 10/02

(52) U.S. Cl. 705/5

(57) ABSTRACT

A system for managing a reservation container associated with a reservation. The system comprising a controller for executing a set of instructions and a controller-readable medium storing the set of instructions which, when executed by the controller, cause the controller to: generate a unique reservation container identifier for enabling subsequent access to the reservation container; set access attributes for the reservation container; and transmit the generated unique reservation container identifier to a service caller.

### BACKGROUND

There is a business need to store ancillary information associated with a passenger reservation for travel. The ancillary information may be connected to a business requirement or to support a sales channel such as customer relationship management data. In many instances, customer and other reservation information is shared from one channel to another. The additional information is collected and stored locally at the channel which inherently makes the sharing of data difficult due to the need to distribute copies of the information between the parties.

Currently, the various channels such as web based bookings or telephony bookings for travel reservations create their own local data stores. The result is the creation of multiple copies of the same information which are hard to manage and maintain. The reservation itself, i.e., the passenger name record (PNR), is not structured for accommodation and management of varied content types. The PNR format was created in the late 60's and due to many factors, like entrenched industry standards, the PNR can not be expanded to meet the needs of current systems. The PNR was created for a single access by green screen agent terminals and not the dynamic customer access channels and content needed today. Restructuring of the PNR is a high business risk, expensive and may interfere with international standards for the exchange of PNR information. Many travel providers store additional information outside of the PNR in other data stores but linking them back up to the many instances of a PNR a customer might have is difficult. These data structures are linked to the traveler which makes sense but every reservation that same traveler makes has a different context and data needs which a single version of this ancillary data can not support.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level block diagram of a reservation system according to an embodiment;

FIG. 2 is a high-level block diagram of a controller-based system usable in conjunction with the reservation system according to an embodiment;

FIG. 3 is a high-level block diagram of data objects usable in conjunction with the reservation system according to an embodiment;

FIG. 4 is a high-level process flow diagram of a method of operation of a reservation system according to an embodiment;

FIG. 5 is a high-level block diagram of a directory service according to an embodiment, and;

FIGS. 6A-6C are high-level functional case diagrams of operation of the directory service according to an embodiment.

### DETAILED DESCRIPTION

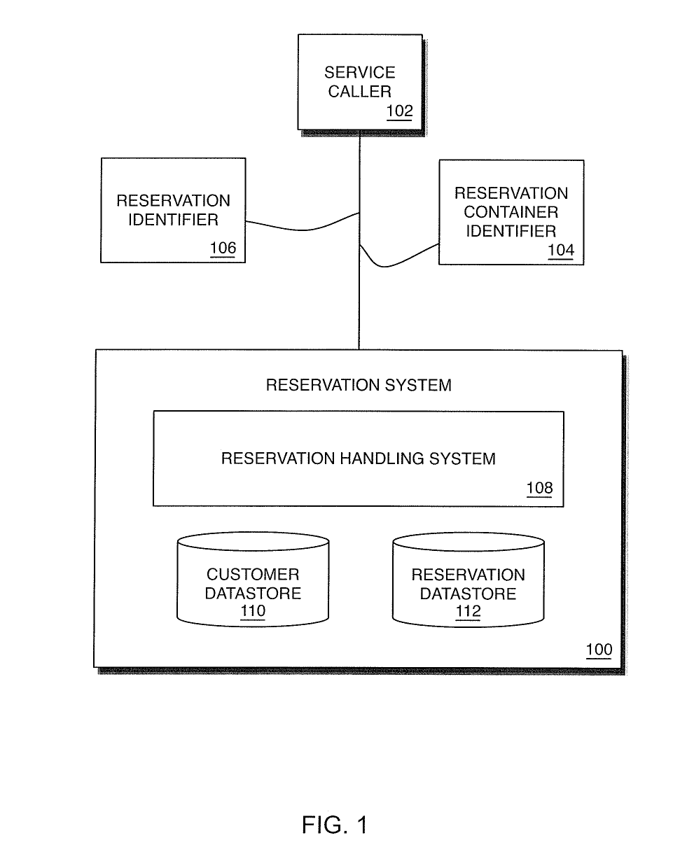

FIG. 1 depicts a high-level block diagram of a reservation system 100 in accordance with an embodiment. The reservation system 100 is a controller or processor-based system for executing one of more sets of instructions. The reservation system 100 is communicatively coupled with a service caller 102. In some embodiments, service caller 102 is a user or a travel or other reservation agent accessing reservation system 100 via network or direction connection using a computer system. For example, service caller 102 may be a travel agent using a sophisticated desktop solution or a customer at a train station kiosk.

In some other embodiments, service caller 102 is a web or other network-based service provider, or similar system accessing reservation system 100 via a network or direct connection. For example, service caller 102 may be a web services implementation as part of a service oriented architecture (SOA).

The service caller 102 accesses the reservation system 100 in order to create, read, update, or delete information related to one or more reservations of an end-user, e.g., a traveler. In accordance with an embodiment, service caller 102 uses a unique reservation container identifier 104 to access information stored in a container relative to a reservation of the end-user in reservation system 100. In at least some embodiments, the reservation is a travel reservation, e.g., a train ticket, etc., or other type reservation. In at least some embodiments, the unique reservation container identifier 104 is a uniform resource identifier (URI) based on and related to a reservation identifier 106. In at least some embodiments, the information stored in the reservation container in reservation system 100 comprises one of a customer profile snapshot, a fare offering, or itinerary planning information. In at least some embodiments, service caller 102 is able to specify and/or manage access attributes of the reservation container.

Advantageously, in comparison to prior systems known to the inventors, information related to the service caller and the particular reservation is able to be stored in relation to the reservation and accessed for a variety of business reasons without requiring local storage or copying of the information at the service caller 102. In at least some embodiments, the information stored includes context information.

For example, in prior systems, a PNR as used in the form of a locator or reservation confirmation number is 6 characters in length and is reused among and/or between reservations for the same or different service callers 102 or end-users. In such systems, archiving old reservations and associating the reservations with a customer is difficult due to the lack of uniqueness.

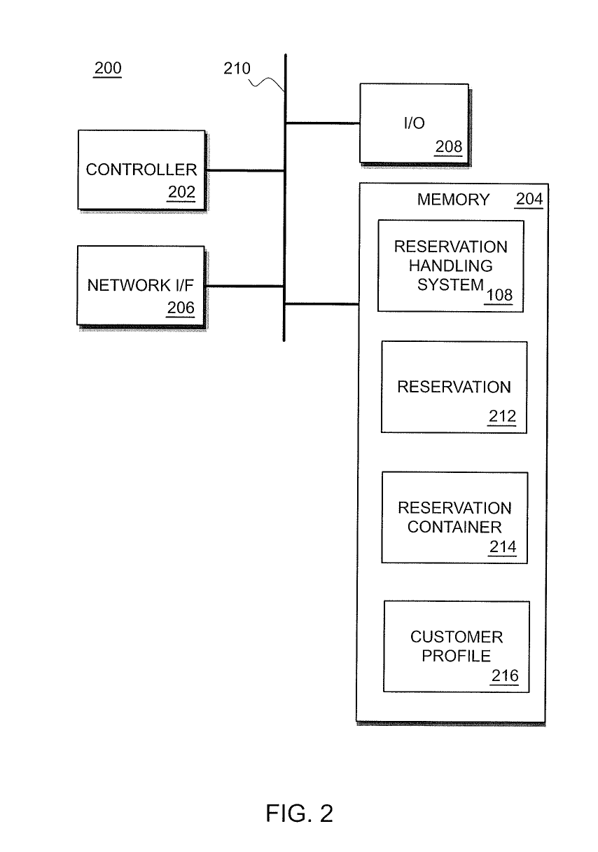

In accordance with at least some of the present embodiments, use of the reservation identifier 106 enables unique identification and association of a reservation (e.g., reservation 212 of FIG. 2) with a customer (e.g., customer 216) or other entities in the reservation system 100.

In at least some embodiments, reservation system 100 supports use of the PNR, as in prior systems, for identifying a reservation (i.e., searching for a reservation) only in conjunction with a unique customer identifier. In at least some further embodiments, a returned reservation identifier is required to be used for further interaction with reservation system 100 in order to prevent confusion and/or increase automation in the reservation and ticketing processes.

Reservation system 100 comprises a reservation handling system 108, a customer datastore 110, and a reservation datastore 112. Reservation handling system 108 comprises a set of executable instructions stored in memory for execution by a processor to cause the processor to perform functionalities according to one or more embodiments. Customer datastore 110 is a database or other data storage structure storing information related to the end-user. Customer datastore 110 stores a customer profile including a customer identifier. Reservation datastore 112 is a database or other data storage structure storing information related to the reservation. Reservation datastore 112 stores a reservation including a reservation ID 106. Additionally, reservation datastore 112 also stores a container including a reservation container ID 104 for storing additional information related to the reservation and/or the customer and/or context information regarding customer and reservation system 100 interaction.

In at least some embodiments, customer datastore 110 and reservation datastore 112 are integrated as a single datastore. In at least some embodiments, one or both of customer datastore 110 and/or reservation datastore 112 are stored on a computer system separate from but communicatively coupled with reservation system 100. In at least some embodiments, both customer datastore 110 and reservation datastore 112 are stored on the same computer system.

### Computer System

FIG. 2 depicts a high-level functional block diagram of a controller-based system 200 usable in conjunction with an embodiment. Controller-based system 200 is also referred to as a computer system and comprises a controller 202 (alternatively referred to as a processor or controller-based device), a memory 204, a network interface (I/F) 206, and an input/output device 208 communicatively coupled via a bus 210 or other interconnection communication mechanism. In at least some embodiments, reservation system 100 is a computer system 200.

Controller 202 is a processor, programmed/programmable logic device, application specific integrated circuit or other similar device configured to execute a set of instructions to perform one or more functions according to an embodiment.

Memory 204 (also referred to as a computer-readable medium) may comprise a random access memory (RAM) or other dynamic storage device, coupled to the bus 210 for storing data and/or instructions to be executed by controller 202. Memory 204 also may be used for storing temporary variables or other intermediate information during execution of instructions to be executed by controller 202. Memory 204 may also comprise a read only memory (ROM) or other static storage device coupled to the bus 210 for storing static information and instructions for the controller 202.

Memory 204 stores reservation handling system 108, zero or more reservations 212, zero or more reservation containers 214, and zero or more customer profiles 216. In at least some embodiments, memory 204 stores customer datastore 110 and reservation datastore 112. In at least some embodiments, reservations 212 and/or reservation containers 214 are stored in reservation datastore 112 in memory 204. In at least some embodiments, customer profiles 216 are stored in customer datastore 110 in memory 204.

Network I/F 206 comprises a mechanism for connecting to a network. In at least some embodiments, computer system 200 comprises more than a single network interface. In at least some embodiments, network I/F 206 may comprise a wired and/or wireless connection mechanism. In at least some embodiments, computer system 200 connects via network I/F 206 to one or more additional computer systems, e.g., service caller 102. In at least some embodiments, computer system 200 connects via bus 210 and/or I/O 208 to one or more additional computer systems, e.g., service caller 102.

A storage device, such as a magnetic disk, optical disk, or electromagnetic disk, may also be provided and coupled to the bus 210 for storing data and/or instructions.

Reservation handling system 108 comprises a set of executable instructions which, when executed by processor 202, cause the processor to provide a reservation handling system according to an embodiment. In at least some embodiments, reservation handling system 108 execution by processor 202 causes the processor to generate a unique reservation container identifier for enabling subsequent access to the reservation container 214. In at least some embodiments, reservation handling system 108 execution by processor 202 causes the processor to set access attributes for the reservation container 214. In at least some embodiments, reservation handling system 108 execution by processor 202 causes the processor to transmit the generated unique reservation container identifier 214 to a service caller 102. In at least some embodiments, reservation handling system 108 execution by processor 202 causes the display of a user interface to a user of computer system, e.g., service caller 102, either via I/O device 208 or network I/F 206.

I/O device 208 may comprise an input device, an output device and/or a combined input/output device for enabling user interaction. An input device may comprise, for example, a keyboard, keypad, mouse, trackball, trackpad, and/or cursor direction keys for communicating information and commands to processor 202. An output device may comprise, for example, a display, a printer, a voice synthesizer, etc. for communicating information to a user. In at least some embodiments, I/O device 208 may comprise a serial and/or parallel connection mechanism for enabling the transfer of one or more of files and/or commands. In at least some embodiments, I/O device 208 is an optional component of computer system 100.

### Data Objects

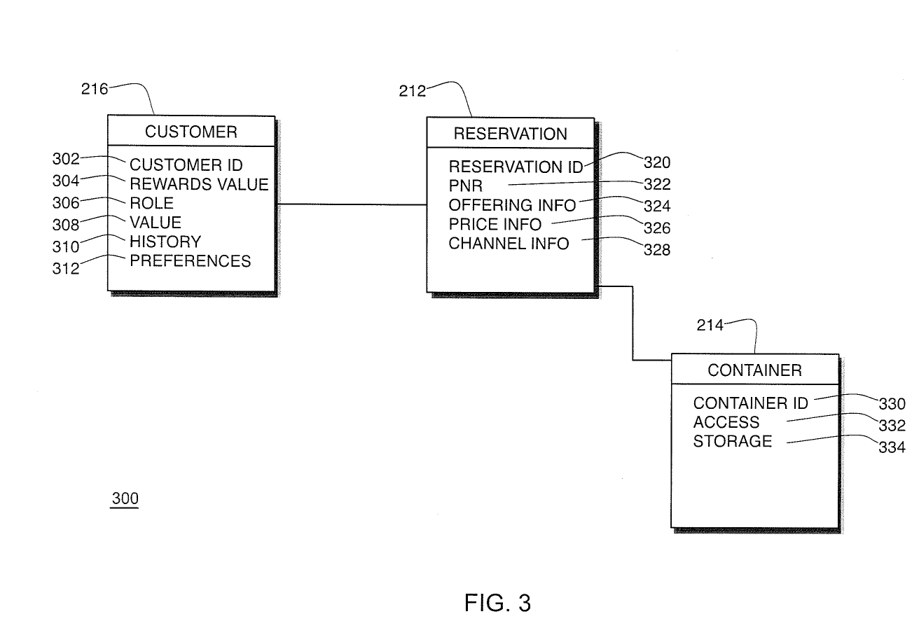

FIG. 3 is a high-level block diagram of a reservation data object set 300 usable in conjunction with the reservation handling system 108 according to an embodiment. In at least some embodiments, data object set 300, and in turn reservation handling system 108, comprises additional data objects usable in conjunction with the reservation handling system sufficient to support execution of the reservation handling system. Further, in at least one embodiment, each of the data objects in reservation data object set 300 comprises executable instructions and/or data structures for implementing the methods and/or storing data related to the particular data object. In at least some embodiments, the particular data objects may be implemented using an object-oriented programming language or system. In other embodiments, a procedural, functional or other type of programming language or system may be used.

Data object set 300 comprises a customer profile 216, a reservation 212, and a reservation container 214.

### Customer Profile

Customer profile 216 stores information related to a customer or end-user of reservation handling system 108. In at least some embodiments, customer profile 216 includes methods for accessing and operating on attributes of the customer. Customer profile 216 is a mechanism for storing the state of the customer and includes summary of interactions with reservation handling system 108. Customer profile 216 comprises attributes including a customer ID 302, a rewards value 304, a role 306, a value 308, a history 310, and preferences 312. In at least some embodiments, customer profile 216 stores additional data and/or information regarding an end-user in one or more additional attributes.

Information in customer profile 216 is accessible to be read by service caller 102; however, there is no direct ability to modify the information in the reservation by the service caller. Instead, service caller 102 modifies one or more pieces of customer profile 216 via reservation handling system 108. In at least some embodiments, customer profile 216 information is stored in a customer relationship management system separate from reservation handling system 108 and/or separate from reservation system 100. In at least some embodiments, the customer relationship management system is accessed by either or both of service caller 102 and reservation system 100 via, for example, a network.

### Customer ID

Customer ID 302 is a unique identifier corresponding to a customer or end-user of the reservation handling system 108. In at least some embodiments, there is a one-to-one mapping between customer ID 302 and an end-user.

Rewards value 304 is a value corresponding to a rewards program, such as a mileage, monetary, or usage based rewards program. In at least some embodiments, rewards value 304 corresponds to a points balance in the Amtrak Guest Rewards program. In at least some embodiments, rewards value 304 is optional.

Role 306 is an attribute usable to specify how the end-user interacts with reservation handling system 108. In at least some embodiments, role 306 comprises a passenger role, a payer role, and arranger role. In at least some embodiments, greater or fewer roles are usable in conjunction with system 108.

Value 308 is a value assigned to the particular customer with respect to the system 108. For example, in some embodiments, value 308 corresponds to whether a customer is a particular level of value to the company of the handling system 108, e.g., a VIP level, a Platinum level, or other suitable level based valuation.

History 310 is an attribute usable to store information related to prior interactions between the end-user and reservation handling system 108. In at least some embodiments, history 310 stores information corresponding to the history of purchases by a customer with the system 108. In at least some embodiments, history 310 is usable to recall a prior paid itinerary.

Preferences 312 is an attribute usable to store end-user preferences regarding interactions and/or reservation or travel preferences of the end-user. In at least some embodiments, preferences optionally stores payment method(s) used, a particular order of contact information to be used for contacting a customer in the event of delays or other needs, for marketing, for dietary restrictions or preferences, for the need for comfort animals to travel with the end-user.

### Reservation

Customer profile 216 is usable in conjunction with a reservation 212. In at least some embodiments, reservation 212 is directly tied to customer profile 216. In at least some other embodiments, there is no direct tie between reservation 212 and customer profile 216. In at least some embodiments, a customer profile 216 may be related to one or more reservations 212. For example, a single end-user may have more than one reservation at a given time.

Reservation 212 is a mechanism for storing the state of the relationship between the reservation handling system 108 and the customer with respect to the particular reservation. Reservation 212 comprises attributes including a Reservation ID 320, a passenger name record (PNR) 322, offering information 324, price information 326, and channel information 328. In at least some embodiments, reservation 212 stores additional data and/or information regarding a reservation in one or more additional attributes.

Prior to and during travel, reservation 212 is dynamically updated by reservation handling system 108 in order to reflect the current state of the end-user's trip. After completion of the related trip, reservation 212 is static with fewer update of the stored information.

Information in reservation 212 is accessible to be read by service caller 102; however, there is no direct ability to modify the information in the reservation by the service caller. Instead, service caller 102 modifies one or more pieces of reservation 212 via reservation handling system 108.

### Reservation ID

Reservation ID 320 is a unique identifier corresponding to a reservation obtained by service caller 102 for the end-user. In at least some embodiments, reservation ID 320 is a uniform resource identifier (URI) uniquely identifying a link to the reservation 212 stored in reservation datastore 112 in memory 204. For example, a particular reservation may be accessible at “Amtrak.com/Bullet/Reservation/xxxyyyzzz” where “xxxyyyzzz” uniquely identifies the reservation. In at least some embodiments, reservation ID 320 is usable to identify a network address for access by a browser or similar software executing by a processor on a remotely connected computer system. In at least some other embodiments, reservation ID 320 is usable by the reservation handling system 108 to access reservation 212. In at least some embodiments, standard mechanisms are applied to generate a unique ID for reservation container ID 330.

Reservation ID 106 may be an instance of reservation ID 320.

PNR 322 is an attribute for storing information related to a legacy system for handling reservations. PNR 322 is used to access a computer reservation system storing itinerary details for a passenger or group of passengers. In at least some embodiments, PNR 322 comprises the current state of a reservation for an end-user including offering information 324, price information 326, and channel information 328. In at least one embodiment, reservation 212 is a pointer to PNR 322 and reservation ID 320 is a unique name for the reservation.

Offering information 324 is an attribute storing information related to the product reserved by the end-user. For example, product information may identify a particular train number to which the reservation is applied, a particular car, seat, or room number may also be identified. Product information 324 captures information related to the good and/or service reserved or purchased by the end-user.

Price information 326 is an attribute storing information related to the price at which the product was purchased.

Channel information 328 is an attribute storing information related to the mechanism by which the service caller 102 interacts with reservation handling system 108. For example, channel information 328 may indicate that the interaction is via a travel agent at a terminal, a web-based SOAP, or ticket counter. In at least some embodiments, channel information 328 stores information related to particular offering and/or payment options are to be presented service caller 102 depending on the channel used to access reservation handling system 108.

Reservation 212 is usable in conjunction with a reservation container 214. Reservation container 214 is directly tied to reservation 212.

In at least some embodiments, reservation 212 is stored and made available as one or more extensible markup language (XML) based documents. In at least some other embodiments, reservation 212 stores PNR 322 as a known PNR record format instead of an XML-based document. In some further embodiments, reservation handling system 108 or reservation 212 is configured to generate an XML-based version of PNR 322.

### Reservation Container

Reservation container 214 (also referred to as a reservation folder or simply a folder) stores information related to the reservation which is accessible, depending on access attribute 332, and updateable by service caller 102 in addition to reservation handling system 108. In contrast with customer profile 216 and reservation 212, service caller 102 is able, depending on access attribute setting 332, to directly access and modify information in reservation container 214.

Reservation container 214 exists in connection with reservation 212. The lifetime of reservation container 214 is the same as the lifetime of reservation 212.

Reservation container 214 comprises attributes including a container ID 330, access attribute 332, and storage 334.

### Reservation Container ID

Reservation Container ID 330 is a unique identifier corresponding to a reservation container 214 obtained by service caller 102 for the end-user. In at least some embodiments, reservation container ID 330 is a uniform resource identifier (URI) uniquely identifying a link to the reservation container 214 stored in connection with a reservation 212 in reservation datastore 112 in memory 204. For example, a particular reservation container may be accessible at “Amtrak.com/Bullet/Reservation/xxxyyyzzz/containerABC” where “containerABC” uniquely identifies the reservation container. In at least some embodiments, reservation container ID 330 is usable to identify a network address for access by a SOAP, a browser or similar software executing by a processor on a remotely connected computer system. In at least some other embodiments, reservation container ID 330 is usable by the reservation handling system 108 to access a particular reservation container 214. In at least some embodiments, standard mechanisms are applied to generate a unique ID for reservation container ID 330.

Reservation container ID 104 may be an instance of reservation container ID 330.

Access attribute 332 is an attribute storing access settings for determining access to reservation container 214 by service caller 102. Access attribute 332 specifies whether a service caller 102 is able to read, update, and/or delete reservation container 214. In at least some embodiments, access attribute 332 specifies access settings on a per service caller basis. In at least some embodiments, access attribute 332 specifies access settings based on the role of a particular service caller 102 or customer role 306. In at least some embodiments, access attribute 332 specifies access settings based on the channel information 328 by which the reservation 212 is created.

Access attribute 332, in some embodiments, also stores an identifier of the service caller 102 that created the reservation container 214. On creation of the reservation container 214, the creating service caller 102 can modify the access attribute 332 of the reservation container.

Service caller 102 may set access attribute 332 to allow only access to read, update, or delete the container 214 by the same service caller 102, to allow access to read by anyone, but updated or deleted by the same service caller, or to allow access to read, update, or delete by anyone.

In at least some embodiments, service caller 102 is able to assign a particular name or alias to the reservation container 214 for ease of reference in the future.

Storage 334 is a representation of the location in which information is storable by the service caller 102 and others based on attribute 332 settings. In at least some embodiments, storage 334 is used to store availability information related to offering information 324 which was available at the time the service caller 102 made the reservation. In at least some embodiments, storage 334 is used to store price information 326 which was displayed or offered to the service caller 102 at the time a reservation was created. In this manner, the reservation handling system 108 is able to retain and recreate a snapshot and/or time history of the context in which the service caller 102 made the reservation. The stored information may be used later by reservation handling system 108 and/or a human agent of the system 108 assisting an end-user or service caller 102 regarding assistance for a reservation. The stored information provides context with respect to pricing being quoted to the end-user or service caller 102.

In a still further scenario, storage 334 may store a copy of all or a portion of a customer profile in order to store the state of the user profile at the time a reservation is made. For example, the number of frequent traveler points at the time of reservation may be stored.

In another scenario, storage 334 may store a copy of the fare information available to the end-user at the time of reservation.

In at least some embodiments, service caller 102 may store additional information in storage 334 beyond that which is found in the reservation handling system 108. For example, service caller 102 may store a frequent reward program snapshot information related to the end-user at the time of reserving in storage 334.

In at least some embodiments, reservation container 214 and the contents of storage 334 are stored and made available as one or more XML based documents. In at least some other embodiments, reservation container 214 and the contents of storage 334 may be stored and made available as text, binary, or other formats.

By use of the above mechanism, different service callers 102 representing different entities such as a travel agent and an end-user are able to store information in connection with the reservation 212. In at least some embodiments, each reservation 212 may be connected with more than one reservation container 214. Stated another way, there may be more than one reservation container 214 in connection with one reservation 212.

In accordance with an embodiment, a remote service caller 102 is unable to store a copy of a PNR attribute information locally at the service caller computer system. Reservation handling system 108 provides access to the reservation 212, customer profile 216, and reservation container 214 information.

### Relation Between Reservation and Reservation Container

In at least one embodiment, reservation 212 and reservation container 214 are related in a hierarchical manner such that the reservation container is a lower level relation to the reservation. That is, in order to address reservation container 214, the address of the reservation from which the reservation container relates is needed. Stated another way, the address used to access the reservation container 214 comprises the address used to access the reservation.

In a particular given example, reservation 212 is addressable by using the reservation ID 320 having a value of “Amtrak.com/Bullet/Reservation/JohnsonMary202” and a reservation container 214 is addressable (accessible) by using the reservation container ID 330 having a value of “Amtrak.com/Bullet/Reservation/JohnsonMary202/container1”. Thus, the container, i.e., “container1”, is accessible based on at least a portion of the reservation ID 320. Also, in some embodiments, the address of the corresponding reservation 212 may be determined given the reservation container ID 330 of a reservation container 214 which is related to the reservation.

### Operation

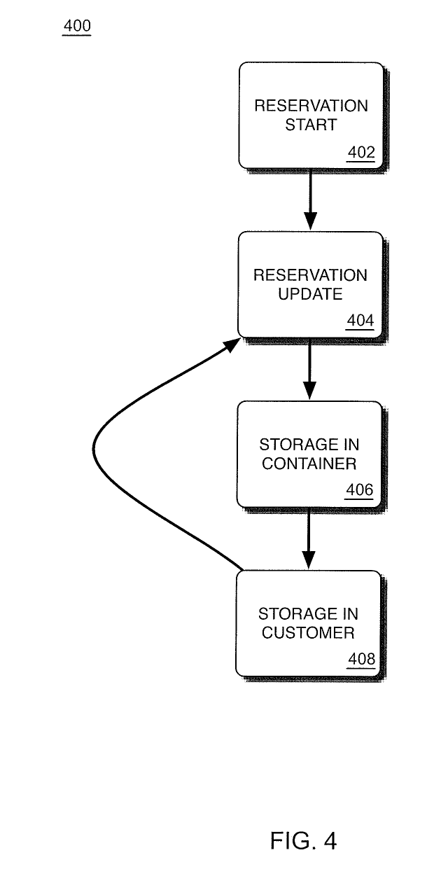

FIG. 4 is a high-level process flow diagram of at least a portion of a method of operation 400 of a reservation system executing a reservation handling system 108 (FIG. 1) according to an embodiment. Operation flow 400 comprises the execution of reservation handling system 108, comprising a set of executable instructions, by controller 202. A customer profile 216 corresponding to a customer or end-user exists in customer datastore 110 in memory 204.

The process flow begins at functionality 402 in which an itinerary for a travel reservation is initiated for the customer. A service caller 102 (for example a travel agent) accesses reservation handling system 108 using a terminal or computer system connected with reservation system 100 via network I/F 206 and requests the creation of a reservation 212 for the customer. The service caller 102 provides the customer ID 302 to the system 108.

Upon receipt of the request, reservation handling system 108 creates a new reservation 212 in reservation datastore 112 in memory 204. Reservation handling system 108 generates and assigns a unique reservation ID 330 to the newly created reservation 212. In at least some embodiments, a name is also assigned based on information provide by the service caller 102.

The flow then proceeds to functionality 404 wherein execution of at least a portion of the sequence of instructions comprising reservation handling system 108 causes the processor to update the reservation. System 108 creates a new reservation container 214 in reservation datastore 112 in memory 204. Reservation handling system 108 generates and assigns a unique reservation container ID 330 to the newly created reservation container 214. In at least some embodiments, the generated reservation container ID 330 is generated based on at least a portion of the reservation ID 320. In at least some embodiments, the generated reservation container ID 330 includes the entirety of the reservation ID 320 as a portion of the generated unique reservation container ID. Reservation handling system 108 transmits the reservation ID 320 and reservation container ID 330 to the service caller 102.

After creation of reservation container 214, system 108 stores one or more attributes of customer profile 216 and/or other customer information to the reservation container, e.g., in storage 334. In at least some embodiments, reservation handling system 108 stores a customer profile snapshot, a fare offering, or itinerary planning information.

Additionally, system 108 sets default access attribute 332 values based on customer profile 216 and/or service caller 102 information. The process flow then proceeds to functionality 406 wherein service caller 102 can cause the storage of information in reservation container 214.

Responsive to receipt of a request or information being provided by service caller 102, reservation handling system 108 stores additional information received from the service caller in storage 334.

At this point in the process flow, the service caller may retrieve, e.g., an XML-based document of the, information from reservation 212 and/or reservation container 214.

The process flow then proceeds to functionality 408 wherein execution of at least a portion of the sequence of instructions comprising reservation handling system 108 causes the processor to store information in customer profile 216. In particular, a summary of reservation information is stored in customer profile 216 and the customer profile and the reservation 212 are linked to each other based on the reservation ID 320 stored in the customer profile.

At this point, service caller 102 is able to access customer profile 216, reservation 212, and reservation container 214. Subsequent updates to the reservation or information stored in the reservation container may be performed by returning execution to functionality 404.

In at least some embodiments, service caller 102 is able to access reservation container 214 directly through the use of reservation container ID 330.

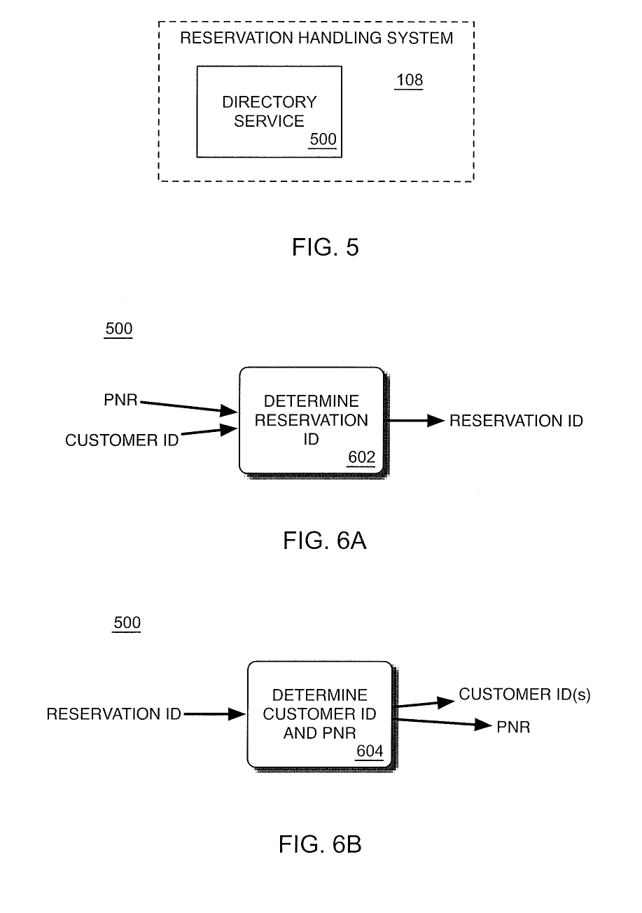

FIG. 5 is a high-level block diagram of a directory service 500 according to an embodiment. Directory service 500 comprises a set of executable instructions which, when executed by a processor (e.g., processor 202), cause the processor to provide a directory service according to an embodiment.

In at least some embodiments, directory service 500 is separate from reservation handling system 108. In at least some other embodiments, directory service 500 is installed on and executed by a separate computer system from reservation system 100.

In at least some embodiments, directory service 500 maintains a data structure or other mechanism for associating between the PNR 322, reservation ID 320, and/or customer ID 302. In at least some embodiments, the linkage among the associated elements may be stored in the form of a tuple. In at least some embodiments, the association is stored in reservation system 100.

In at least some embodiments, directory service 500 is able to determine one or more of the other elements, i.e., PNR 322, reservation ID 320, or customer ID 302, responsive to receipt of one or more of the elements. Directory service 500, in some embodiments, accesses one or more of customer datastore 110, reservation datastore 112, or other datastores in memory 204 or connected to reservation system 100.

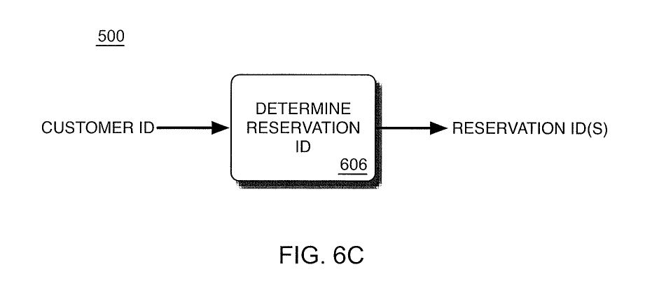

FIGS. 6A-6C are high-level functional case diagrams of operation a determine reservation ID functionality 602 of the directory service 500. FIG. 6A is a case diagram depicting operation of determine reservation ID 602 responsive to receipt of PNR 322 and customer ID 302 to identify the corresponding reservation ID 320. Because the PNR 322 may not uniquely identify a particular reservation ID 320, determine reservation ID functionality 602 (in at least some embodiments) requires receipt of the additional unique discriminator customer ID 302 in order to determine the corresponding reservation ID 320.

FIG. 6B is a case diagram depicting operation of determine customer ID and PNR 604 responsive to receipt of reservation ID 320 (a uniquely identified reservation ID in accordance with present embodiments) to identify the corresponding customer ID(s) 302 and PNR 322. Because the reservation ID 320 uniquely identifies the reservation 212, determine customer ID and PNR functionality 604 is able to identify the associated customer(s) 216 by way of the customer ID 302 and identify the PNR 322 based on the corresponding field in the reservation. Because each reservation 212 may, in some embodiments, be associated with more than one customer, the determine customer ID and PNR functionality 604 may return more than one customer ID 302 associated with a particular reservation 212.

FIG. 6C is a case diagram depicting operation of determine reservation ID 606 responsive to receipt of customer ID 302 (a uniquely identified customer ID in accordance with present embodiments) to identify the corresponding reservation ID(s) 320 associated with the customer 216. Because the customer ID uniquely identifies the customer 216, determine reservation ID functionality 606 is able to identify the associated reservation(s) 212 by way of the reservation ID 320 associated with the customer 216. Because each customer ID 216 may, in some embodiments be associated with more than one reservation 212, the determine reservation ID functionality 606 may return more than one reservation ID 320 associated with a particular reservation.

In at least some embodiments, the functionality of FIGS. 6A-6C may be chained one to the other in order to determine particular information. For example, responsive to receipt of a particular reservation ID, determine customer ID and PNR 604 functionality determines the corresponding customer IDs 302 for the particular reservation which are then supplied to determine reservation ID 606 functionality in order to determine the reservation IDs 320 for the corresponding customer IDs 302.

With respect to the functionality of directory service 500, e.g., one or more of which is represented by FIGS. 6A-6C, which functionality and how much functionality are made accessible (i.e., exposed) to another accessing entity such as service caller 102 may be limited. In at least some embodiments, directory service 500 or reservation handling system 108 is executed to control the particular functionality provided to service caller 102. For example, in at least one embodiment, directory service 500 executing the functionality described in conjunction with FIG. 6B returns only information related to a single customer ID 302. Similar restrictions may be applied to the functionality in FIGS. 6A-6C.

In at least one or more embodiments, reservation system 100 also stores a name of the reservation provided by service caller 102 as part of the reservation 212 in reservation datastore 112. In at least some embodiments, a particular channel, e.g., a particular service caller 102, such as a travel or other booking agent allows an end-user to provide a name for a reservation. In at least some other embodiments, the particular channel (service caller 102) uses the name storage option provided by the reservation system 100 to store a uniquely identifying name, in accordance with a naming convention of the channel, for the reservation 212 in reservation datastore 112.

Various distribution channels or business systems may now associate and store information that is necessary for later use in the context of a single reservation. They may store any data they want in any format they want. The reservation system itself is not a user of this information, only a data store. For example a CRM solution may use this feature to store user profile information in a folder expressed as meta data. At any customer contact point the channel involved can use the meta-data with a local rules engine. This will allow anyone working with the same customer on their reservation to have the same profile information without having to separately interact with the CRM system. This will save on cost by removing the need to support a high volume, highly available CRM system. Another example is one channel, such as telephony, needs to transfer the call to a sales agent to resolve an issue. The necessary information such as what the customer has been shown in the way of travel solutions and fares may be stored in a folder so the sales agent may access along with the reservation and be able to pick up where the previous channel left off without asking the customer to recount the transaction.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A system for managing a reservation container associated with a reservation object, comprising:
a controller for executing a set of instructions; and
a controller-readable medium storing the set of instructions which, when executed by the controller, cause the controller to:
generate a unique reservation container identifier for enabling subsequent access to the reservation container;
set access attributes for the reservation container; and
transmit the generated unique reservation container identifier to a service caller.

2. The system as claimed in claim 1, wherein the set of instructions further comprises instructions which, when executed by the controller, cause the controller to:
export one or more items storable in the reservation container.

3. The system as claimed in claim 2, wherein the export of the one or more items comprises export in a structured markup language format.

4. The system as claimed in claim 2, wherein the one or more items storable in the reservation container comprise at least one of a customer profile snapshot, a fare offering, or itinerary planning information.

5. The system as claimed in claim 1, wherein the unique reservation container identifier is usable as a uniform resource identifier by the service caller.

6. The system as claimed in claim 1, wherein the reservation container is arranged to store one or more data objects.

7. The system as claimed in claim 1, wherein the set of instructions further comprises instructions which, when executed by the controller, cause the controller to:
generate a unique reservation identifier associated with the reservation object.

8. The system as claimed in claim 1, wherein the reservation container identifier comprises at least a portion of the unique reservation identifier.

9. The system as claimed in claim 1, wherein the set of instructions further comprises instructions which, when executed by the controller, cause the controller to:
generate a passenger number record confirmation number associated with the reservation object.

10. A method of managing a reservation container associated with a reservation object, comprising:
generating a unique reservation container identifier for subsequent access to the reservation container;
setting access attributes for the reservation container; and
transmitting the generated unique reservation container identifier to a service caller.

11. The method of claim 10, the reservation container storing one or more items, the method further comprising:
exporting one or more of the stored one or more items from the reservation container.

12. The method of claim 11, wherein the exporting comprises exporting in a structured markup language format.

13. The method of claim 10, further comprising:
storing one or more of a customer profile snapshot, a fare offering, or itinerary planning information in the reservation container.

14. The method of claim 10, further comprising:
transmitting one or more stored items from the reservation container to the service caller responsive to receipt of the reservation container identifier.

15. The method of claim 14, the access attributes specifying one or more customer identifiers and corresponding access rights and wherein the transmitting is performed responsive to receipt of a requesting customer identifier matching a specified customer identifier of the reservation container having sufficient access rights.

16. The method of claim 10 wherein the generated reservation container identifier is generated based on a reservation identifier.
